(19) United States
(12) Patent Application Publication
(10) Pub. No.: US 2004/0111624 A1
(43) Pub. Date: Jun. 10, 2004

(54) Reader and authentication device using the same

(75) Inventors: Akihiro Odagawa, Tsuchiura-shi (JP); Yasunari Sugita, Osaka-shi (JP)

Correspondence Address: MERCHANT & GOULD PC, P.O. BOX 2903, MINNEAPOLIS, MN, 55402-0903, US

(73) Assignee: MATSUSHITA ELECTRIC INDUSTRIAL CO., Kadoma-shi (JP)

(21) Appl. No.: 10/717,059

(22) Filed: Nov. 18, 2003

Related U.S. Application Data
(63) Continuation of application No. PCT/JP03/08455, filed on Jul. 3, 2003.

(30) Foreign Application Priority Data
Jul. 5, 2002 (JP) 2002-197035

(51) Int. Cl. H04L 9/00

(52) U.S. Cl. 713/185; 713/186

(57) ABSTRACT

A reader of the present invention reads the shape of the surface of an object and includes a magnetic displacement portion and a detecting portion. When the magnetic displacement portion comes into contact with the surface of the object, the magnetic state of the magnetic displacement portion differs depending on the shape of the surface. The detecting portion detects the magnetic state of the magnetic displacement portion. An authentication device of the present invention includes the reader, a memory, and a matching portion. The memory stores the shape of the surface of an object beforehand. The matching portion matches the shape read by the reader with the shape stored in the memory. The reader and the authentication device can use the magnetic displacement as a detection technique.

### BACKGROUND OF THE INVENTION

1. Field of the Invention

The present invention relates to a reader and an authentication device using the reader.

2. Description of the Related Art

The authentication of individuals is necessary under various circumstances in our lives today. For example, the management of bank accounts or the transmission of information using communication lines such as the Internet requires verifying the identity of contracting parties. In a general authentication method, the predetermined passwords/symbols of individuals are input and verified every time they are needed. This method is used widely because of its very simple operation (e.g., facilitating both registration and authentication of the passwords/symbols). In recent years, however, there have been demands for the authentication of individuals on many occasions. Therefore, a person should have passwords/symbols for each of the occasions, so that it is difficult for the person to remember all the passwords/symbols. To solve this problem, biometric authentication that utilizes person's physical characteristics, particularly the surface shape of a fingerprint or the like, is expected as a simple authentication method. The fingerprint authentication requires a reader that can detect the shape of a fingerprint. The current readers for detecting the shape of a fingerprint (and the current authentication devices using the readers) are classified into three major categories according to their detection techniques: capacitance type, thermosensitive type, and optical type (e.g., JP 2000-501640 A discloses a thermosensitive authentication device). Depending on the type, these readers have their advantages and disadvantages: for example, the advantage is that a CMOS process can be applied to produce the readers, while the disadvantage is that the readers are susceptible to static electricity or environmental temperature changes and there is a limit to the size reduction of the readers.

### SUMMARY OF THE INVENTION

Unlike the above detection techniques, it is an object of the present invention to provide a reader that uses a variation in magnetic state (magnetic displacement) as a detection technique and an authentication device using the reader.

A reader of the present invention reads the shape of the surface of an object and includes a magnetic displacement portion and a detecting portion. When the magnetic displacement portion comes into contact with the surface of the object, the magnetic state of the magnetic displacement portion differs depending on the shape of the surface. The detecting portion detects the magnetic state of the magnetic displacement portion.

In the reader of the present invention, the shape of the surface may include a convex portion and a concave portion, and the magnetic state of the magnetic displacement portion may differ between a region facing the convex portion and a region facing the concave portion due to a pressure generated by contact of the surface with the magnetic displacement portion.

In the reader of the present invention, the magnetic displacement portion may include a transition material for converting mechanical energy into magnetic energy.

In the reader of the present invention, the transition material may include a magnetostrictive material.

In the reader of the present invention, the transition material may include a material with a composition expressed by Fe—Z, where Z is at least one element selected from the group consisting of Mn, Co, Ni, Cu, Al, Si, Ga, Pd, Pt, Tb, and Dy.

In the reader of the present invention, the amount of change in deformation of the transition material may be not less than 10⁻³%.

In the reader of the present invention, the magnetic displacement portion further may include a soft magnetic layer, the soft magnetic layer and the transition material may be coupled magnetically, and the magnetic state of the soft magnetic layer may differ depending on the magnetic state of the transition material.

In the reader of the present invention, the detecting portion may include a coil and detects the magnetic state by using the coil.

In the reader of the present invention, the detecting portion may include a magnetoresistive element and detects the magnetic state by using the magnetoresistive element.

In the reader of the present invention, the magnetoresistive element may include a multilayer structure that includes a non-magnetic layer and a pair of magnetic layers sandwiching the non-magnetic layer; a resistance value may differ depending on a relative angle between the magnetization directions of the magnetic layers; the magnetic displacement portion may include a transition material for converting mechanical energy into magnetic energy; and the magnetization direction of one of the magnetic layers may differ depending on the magnetic state of the transition material.

In the reader of the present invention, one of the magnetic layers and the transition material may be coupled magnetically.

In the reader of the present invention, the magnetoresistive element further may include an antiferromagnetic layer, and the antiferromagnetic layer may be arranged so that the other magnetic layer is sandwiched between the antiferromagnetic layer and the non-magnetic layer.

In the reader of the present invention, at least one magnetic layer selected from the pair of magnetic layers may include a non-magnetic film and a pair of magnetic films sandwiching the non-magnetic film.

In the reader of the present invention, magnetic coupling selected from laminated ferrimagnetic coupling and magnetostatic coupling may be established between the pair of magnetic films.

In the reader of the present invention, the magnetic displacement portion may be fixed in the direction perpendicular to the surface of the object.

In the reader of the present invention, the magnetic displacement portion may be movable in the direction perpendicular to the surface of the object.

In the reader of the present invention, the magnetic displacement portion may be arranged in at least one form selected from a point, a line, and a plane.

In the reader of the present invention, the detecting portion may be arranged in at least one form selected from a point, a line, and a plane.

The reader of the present invention further may include a first scanning portion for moving the magnetic displacement portion, and the first scanning portion may move the magnetic displacement portion along the surface of the object so that the shape of the surface is read.

The reader of the present invention further may include a second scanning portion for moving the detecting portion, and the second scanning portion may move the detecting portion along the magnetic displacement portion so that the magnetic state of the magnetic displacement portion is detected.

In the reader of the present invention, the object may be a human body.

In the reader of the present invention, the shape of the surface may be a fingerprint.

An authentication device of the present invention includes a reader, a memory, and a matching portion. The reader reads the shape of the surface of an object and includes a magnetic displacement portion and a detecting portion. When the magnetic displacement portion comes into contact with the surface of the object, the magnetic state of the magnetic displacement portion differs depending on the shape of the surface. The detecting portion detects the magnetic state of the magnetic displacement portion. The memory stores the shape of the surface of an object beforehand. The matching portion matches the shape read by the reader with the shape stored in the memory.

### BRIEF DESCRIPTION OF THE DRAWINGS

FIGS. 1A and 1B are schematic cross-sectional views showing an example of a reader of the present invention.

FIGS. 2A and 2B are schematic cross-sectional views showing another example of a reader of the present invention.

FIG. 3 is a schematic cross-sectional view showing yet another example of a reader of the present invention.

FIG. 4 is a schematic cross-sectional view showing still another example of a reader of the present invention.

FIG. 5 is a schematic cross-sectional view showing an example of a magnetoresistive element used in a reader of the present invention.

FIG. 6 is a schematic cross-sectional view showing another example of a magnetoresistive element used in a reader of the present invention.

FIG. 7 is a schematic cross-sectional view showing yet another example of a magnetoresistive element used in a reader of the present invention.

FIGS. 8A to 8D are schematic diagrams, each showing an example of the arrangement of a magnetic displacement portion used in a reader of the present invention.

FIGS. 9A to 9D are schematic diagrams, each showing an example of the arrangement of a detecting portion used in a reader of the present invention.

FIG. 10 is a schematic cross-sectional view showing an example of a reader of the present invention that is different from the above example.

FIG. 11 is a schematic diagram showing an example of the operation of a reader of the present invention.

FIG. 12 is a schematic diagram showing another example of the operation of a reader of the present invention.

FIG. 13 is a schematic diagram showing yet another example of the operation of a reader of the present invention.

FIG. 14 is a schematic diagram showing an example of the configuration of a reader of the present invention.

FIG. 15 is a schematic diagram showing another example of the configuration of a reader of the present invention.

FIGS. 16A to 16F are schematic cross-sectional views showing an example of a method for manufacturing a reader of the present invention.

FIG. 17 is a schematic diagram showing an example of an authentication device of the present invention.

FIG. 18 shows the result of reading the shape of a fingerprint that was measured in Examples.

FIGS. 19A to 19G are schematic cross-sectional views showing another example of a method for manufacturing a reader of the present invention.

### DESCRIPTION OF THE PREFERRED EMBODIMENTS

Hereinafter, embodiments of the present invention will be described with reference to the drawings. In the following embodiments, the identical elements are denoted by the same reference numerals, and the description may not be repeated.

The following is an explanation of a reader of the present invention.

The reader of the present invention reads the shape of the surface an object and includes a magnetic displacement portion and a detecting portion. When the magnetic displacement portion comes into contact with the surface of the object, the magnetic state of the magnetic displacement portion differs depending on the shape of the surface. The detecting portion detects the magnetic state of the magnetic displacement portion. The magnetic state is not particularly limited as long as it is a magnetic parameter of the magnetic displacement portion. For example, the magnetic state represents the magnitude of a magnetic flux generated from the magnetic displacement portion or the direction and/or magnitude of magnetization of the magnetic displacement portion.

Unlike a general reader, this reader can use a variation in magnetic state (magnetic displacement) as a detection technique. Therefore, the reader is less affected by the environment such as static electricity and temperature. This reader also can achieve a smaller size and lower power consumption because optical components (e.g., a light source or lens) or other components (e.g., a heater) can be removed. Moreover, a general device manufacturing process or semiconductor manufacturing process can be used to produce the reader of the present invention, which will be described later. The reader may have these effects selectively and does not need to have all of them simultaneously.

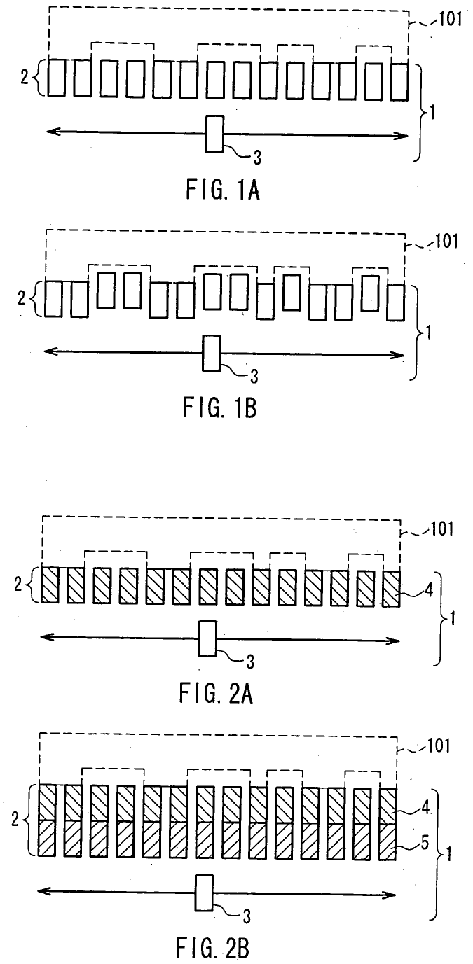

FIGS. 1A and 1B show an example of a reader of the present invention. A reader 1 in FIGS. 1A and 1B includes a magnetic displacement portion 2 and a detecting portion 3. When the magnetic displacement portion 2 comes into contact with the surface of an object 101, the magnetic state of the magnetic displacement portion 2 differs depending on the shape of the surface. The detecting portion 3 detects the magnetic state of the magnetic displacement portion 2. The detecting portion 3 in FIGS. 1A and 1B can detect the magnetic state of the magnetic displacement portion 2 by moving along the magnetic displacement portion 2 (e.g., in the directions of the arrows respectively shown in FIGS. 1A and 1B). Specific examples of the magnetic displacement portion 2 and the detecting portion 3 will be described later. FIGS. 1A and 1B, which are schematic cross-sectional views of the reader of the present invention, omit hatching so as to make the description easy to understand, and hatching is omitted partially in the following drawings.

In the reader of the present invention, the shape of the surface of an object includes a convex portion and a concave portion, and the magnetic state of the magnetic displacement portion may differ between a region facing the convex portion and a region facing the concave portion due to a pressure generated by contact of the surface of the object with the magnetic displacement portion.

As shown in the examples of FIGS. 1A and 1B, when the object 101 having a surface with convex and concave portions comes into contact with the magnetic displacement portion 2, a pressure applied from the object 101 differs between a region of the magnetic displacement portion 2 that faces the convex portion and a region of the magnetic displacement portion 2 that faces the concave portion. For example, when the magnetic displacement portion 2 includes a material whose magnetic state differs depending on the pressure, it can have the magnetic distribution in accordance with the shape of the object 101. This distribution can be detected by the detecting portion 3, thus reading the shape of the surface of the object 101. To read the shape of the surface of the object 101, the magnetic displacement portion 2 should be in contact with the convex portion of the object 101, but may be either in contact or not in contact with the concave portion of the object 101.

The following is an explanation of the magnetic displacement portion 2.

In the reader of the present invention, the material, configuration, or the like of the magnetic displacement portion 2 is not particularly limited as long as the magnetic state differs depending on the shape of the surface of an object. For example, the magnetic displacement portion 2 may include a transition material for converting mechanical energy into magnetic energy. The magnetic displacement portion 2 including the transition material can generate the magnetic distribution in accordance with the shape of the object 101.

FIG. 2A shows another example of a reader of the present invention. In the reader 1 of FIG. 2A, the magnetic displacement portion 2 of the reader 1 in FIG. 1A includes a transition material 4.

The transition material 4 may include, e.g., a magnetostrictive material. The magnetic state (e.g., the magnitude or direction of magnetization) of this type of material varies with mechanical energy such as a pressure. Therefore, the magnetic displacement portion 2 can generate the magnetic distribution in accordance with the shape of the object 101.

The magnetostrictive material is not particularly limited as long as it is a material generally regarded as having the magnetostrictive property. Examples of the magnetostrictive material include the following: Fe, Co, Ni, Ni—Co, Ni—Mn—Ga, Ni—Mn—Al; a material with a composition expressed by Fe—Z, such as Ni—Fe, Fe—Co, Ni—Fe—Co, Fe—Al, Fe—Si, Fe—Al—Si, Fe—Pt, Fe—Pd, Tb—Fe, Dy—Fe, Th—Dy—Fe, or Ni—Fe—Cu; Fe₃O₄, CoFe₂O₄, NiCoFe₂O₄, ferrites (including an orthoferrite and a spinel-type ferrite) such as NiCu ferrite or NiCuCoFe ferrite, sendust; a Laves raw material such as a material with a composition expressed by D-E, where D is at least one element selected from lanthanide, and E is at least one element selected from the group consisting of Ti, V, Cr, Mn, Fe, Co, and Ni; and rare-earth garnet.

For the materials that are not accompanied by a composition ratio, like Ni—Fe, the composition ratio is not particularly limited and can be set arbitrarily according to the necessary properties. The same is true for the following materials.

Alternatively, a metallic oxide with a composition expressed by AMO₃ may be used for the magnetostrictive material, where A is at least one element selected from the group consisting of Y, La, Nd, Sm, Eu, Gd, Tb, Dy, Ho, Bi, Pb, Li, Tl, Sr, Ca, and Ba, and M is at least one selected from the group consisting of Ti, V, Cr, Mn, Fe, Co, and Ni. In particular, A is preferably at least one element selected from the group consisting of Bi, Pb, La, Nd, Sm, Eu, Gd, Tb, Dy, Ho, and Li, and M is preferably at least one element selected from the group consisting of Cr, Mn, Fe, Co, and Ni. A material with the composition expressed by (Bi, La)(Sr, Ca, Ba)MnO₃ is more preferred.

In the reader of the present invention, the amount of change in deformation of the transition material 4 may be, e.g., not less than 10⁻³%, and preferably not less than 10⁻²%. For example, the materials such as Fe—Si and Tb—Dy—Fe satisfy the condition of not less than 10⁻²%. The upper limit of the amount of change in deformation of the transition material 4 is not particularly limited and may be, e.g., not more than 10²%. The transition material can be made thinner and smaller with increasing the amount of change in deformation.

The thickness of the transition material 4 (i.e., the thickness in the direction perpendicular to the surface of the object 101 in contact with the magnetic displacement portion 2; the same is true for every “thickness” in the following description) is not particularly limited and can be set arbitrarily according to the properties of the transition material. For example, the thickness may be in the range of 10 nm to 104 μm, and preferably in the range of 100 nm to 100 μm. The transition material 4 may include not only a single material, but also a multilayer structure with layers made of a plurality of materials.

FIG. 2B shows another example of a reader of the present invention. In the reader 1 of FIG. 2B, the magnetic displacement portion 2 of the reader 1 in FIG. 2A further includes a soft magnetic layer 5, the soft magnetic layer 5 and the transition material 4 are coupled magnetically, and the magnetic state of the soft magnetic layer 5 differs depending on the magnetic state of the transition material 4. In this case, the detecting portion 3 may detect the magnetic distribution of the soft magnetic layer 5. This reader allows the thickness of the transition material 4 to be reduced, so that the magnetic displacement portion 2 can be made thinner even if it includes the soft magnetic layer 5 as compared with the magnetic displacement portion 2 including only the transition material 4. Thus, the reader 1 can achieve a further reduction in size.

A material for the soft magnetic layer 5 is not particularly limited. For example, a soft magnetic alloy such as Co, Co—Fe, Ni—Fe, or Ni—Fe—Co may be used. In particular, when Ni—Fe—Co is used as the soft magnetic alloy, an alloy with an atomic composition ratio expressed by NiₓFe_{y}Co_{z}, where x, y, and z satisfy 0.6≦x≦0.9, 0≦y≦0.3, and 0≦z≦0.4, or an alloy with an atomic composition ratio expressed by Ni_{x′}Fe_{y′}Co_{z′}, where x′, y′, and z′ satisfy 0≦x′≦0.4, 0≦y′≦0.5, and 0.2≦z′≦0.95 is preferred. Since the magnetostrictive property of these soft magnetic alloys is low (not more than 1×10⁻⁵), the soft magnetic layer 5 can have more excellent properties.

In the reader of the present invention, the surface of the magnetic displacement portion 2 to be in contact with the object 101 may include a protective layer for protecting the surface of the magnetic displacement portion 2. In the examples of FIGS. 2A and 2B, e.g., a protective layer for protecting the surface of the transition material 4 may be arranged between the transition material 4 and the object 101. This can provide the reader 1 with more excellent durability. The thickness of the protective layer is not particularly limited as long as the magnetic state of the magnetic displacement portion 2 can differ depending on the shape of the surface of the object 101 when it comes into contact with the protective layer. The thickness may be, e.g., in the range of 0.1 nm to 100 nm.

A material for the protective layer is not particularly limited. Examples of the material include a metallic material such as W, Ta, Au, Pt, or Pd, an inorganic compound material such as Al₂O₃, SiO₂, ZnS, or MoS₂, a carbon material such as diamond-like carbon (DLC), and a resin material such as polyimide or fluorocarbon resin (e.g., Teflon, a registered trademark of DuPont).

A specific method for arranging the magnetic displacement portion 2 will be described later, together with the arrangement of the detecting portion 3.

The following is an explanation of the detecting portion 3.

In the reader of the present invention, the detecting portion 3 may include a coil and detect the magnetic state of the magnetic displacement portion 2 by using the coil. When the detecting portion 3 includes a coil, e.g., the coil picks up a leakage magnetic field from the magnetic displacement portion 2 (specifically, a leakage magnetic field from the transition material 4 in the example of FIG. 2A, and a leakage magnetic field from the transition material 4 and/or the soft magnetic layer 5 in the example of FIG. 2B), thereby detecting the magnetic state of the magnetic displacement portion 2. The detecting portion 3 including the coil can be produced by a general device manufacturing process. Therefore, the reader 1 can be achieved at a lower cost.

The structure of the coil is not particularly limited as long as it can detect the magnetic state of the magnetic displacement portion 2. Therefore, the structure may be set arbitrarily according to the magnetic property of the magnetic displacement portion 2 and the necessary properties for the reader. For example, a single-wound coil may be used as the simplest structure.

A material for the coil is not particularly limited as long as it is a conductive material. Examples of the material include Cu, Al, Ag, Au, Pt, and Ti—N. In particular, a material having a linear resistivity of not more than 100 μΩ·cm is preferred.

In the reader of the present invention, the detecting portion 3 may include a magnetoresistive element (also referred to as “MR element” in the following) and detect the magnetic state of the magnetic displacement portion 2 by using the MR element. When the detecting portion 3 includes an MR element, e.g., the MR element picks up a leakage magnetic field from the magnetic displacement portion 2, thereby detecting the magnetic state of the magnetic displacement portion 2. The detecting portion 3 including the MR element can be produced by a general semiconductor manufacturing process. Moreover, the magnetic displacement portion 2 and the detecting portion 3 can be formed integrally, which will be described later. Therefore, the reader 1 can have more stable properties.

The MR element is not particularly limited as long as it has a magnetoresistance effect, and a general MR element may be used. Examples of the MR element include the following: an element that utilizes an anisotropic magnetoresistance (AMR) effect (AMR element: the AMR effect is a phenomenon in which an electrical resistance of the element differs depending on a relative angle between the magnetization direction of a magnetic film of the element and the direction of a current flowing through the element); an element that utilizes a giant magnetoresistance (GMR) effect (GMR element: the GMR effect is a phenomenon in which an electrical resistance of the element differs depending on a relative angle between the magnetization directions of a pair of magnetic layers that are stacked via a non-magnetic metal layer); and an element that utilizes a tunnel magnetoresistance (TMR) effect (TMR element: the TMR effect is a phenomenon in which an electrical resistance of the element differs depending on a relative angle between the magnetization directions of a pair of magnetic layers that are stacked via a non-magnetic insulating layer). In particular, the GMR and TMR elements are preferred because they can provide a larger magnetoresistance effect.

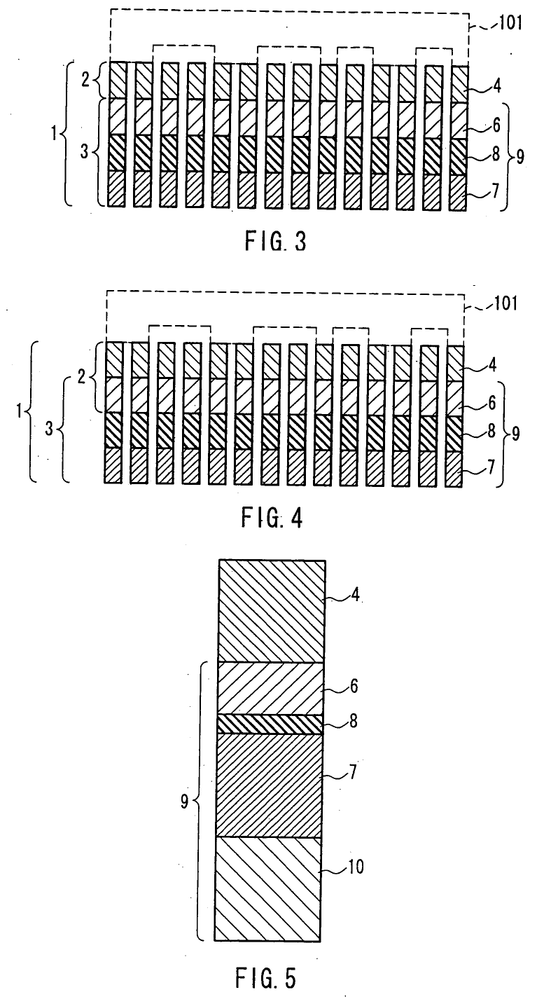

FIG. 3 shows another example of a reader of the present invention. In the reader 1 of FIG. 3, a detecting portion 3 includes an MR element 9, and the MR element 9 detects the magnetic state of a magnetic displacement portion 2. In this example, the MR element 9 includes a multilayer structure that includes a non-magnetic layer 8 and a pair of magnetic layers 6, 7 sandwiching the non-magnetic layer 8. A resistance value of the MR element 9 differs depending on a relative angle between the magnetization directions of the magnetic layers 6, 7. In the reader 1 of FIG. 3, the magnetic displacement portion 2 includes a transition material 4 for converting mechanical energy into magnetic energy, and the magnetization direction of the magnetic layer 6 differs depending on the magnetic state of the transition material 4. For this reader, the MR element serves as a GMR or TMR element, and the electrical resistance of the MR element 9 varies with the magnetization direction of the magnetic layer 6, so that the magnetic state of the transition material 4 (i.e., the magnetic displacement portion 2) can be detected.

The pair of magnetic layers in the MR element generally includes a free layer and a pinned layer. The magnetization direction of the free layer is relatively easy to change, while the magnetization direction of the pinned layer is relatively hard to change. In the example of FIG. 3, the MR element 9 may use the magnetic layer 6 located closer to the magnetic displacement portion 2 as a free layer and the magnetic layer 7 located farther from the magnetic displacement portion 2 as a pinned layer. For this purpose, e.g., the magnetic layer 6 may be coupled magnetically with the magnetic displacement portion 2, the magnetic layer 6 may use a different material from that for the magnetic layer 7, or the MR element further may include an antiferromagnetic layer. Specific examples will be described later. In the example of FIG. 3, the magnetic layer 6 and the transition material 4 are not necessarily in contact with each other.

FIG. 4 shows yet another example of a reader of the present invention. In the reader 1 of FIG. 4, the transition material 4 and the magnetic layer 6 of the reader 1 in FIG. 3 are coupled magnetically. For this reader, an MR element 9 can include the magnetic layer 6 as a free layer and the magnetic layer 7 as a pinned layer. Compared with the reader in which the MR element 9 detects the magnetic displacement of the transition material 4 as a leakage magnetic field, this reader allows the magnetic displacement of the transition material 4 to be reflected more directly in the magnetization direction of the magnetic layer 6. Therefore, the reader 1 can have more excellent properties. When the above soft magnetic layer is used for the magnetic layer 6 (free layer), the magnetic layer 6 can be part of the magnetic displacement portion 2 as well as part of the detecting portion 3. In other words, the magnetic displacement portion 2 and the detecting portion 3 can be formed integrally, so that the reader can have a smaller size and excellent properties. In the example of FIG. 4, the magnetic layer 6 and the transition material 4 are not necessarily in contact with each other as long as they are coupled magnetically.

A material for the magnetic layers 6, 7 is not particularly limited as long as it is a magnetic material. Examples of the material include the following: a single element such as Fe, Co, or Ni; an alloy such as Fe—Co, Ni—Fe, Co—Ni, or Ni—Fe—Co; a magnetic material with a composition expressed by X¹—X²—X³, where X¹ is at least one element selected from the group consisting of Fe, Co and Ni, X² is at least one element selected from the group consisting of Mg, Ca, Ti, Zr, Hf, V, Nb, Ta, Cr, Al, Si, Mg, Ge, and Ga, and X³ is at least one element selected from the group consisting of N, B, O, F, and C, e.g., Fe—N, Fe—Ti—N, Fe—Al—N, Fe—Si—N, Fe—Ta—N, Fe—Co—N, Fe—Co—Ti—N, Fe—Co(Al, Si)—N, or Fe—Co—Ta—N; a magnetic material with a composition expressed by (Co, Fe)—X⁴, where X⁴ is at least one element selected from the group consisting of Ti, Zr, Hf, V, Nb, Ta, Cu, and B; a magnetic material with a composition expressed by X¹-X⁵, where X¹ is at least one element selected from the group consisting of Fe, Co, and Ni, and X⁵ is at least one element selected form the group consisting of Cu, Ag, Au, Pd, Pt, Rh, Ir, Ru, Os, Ru, Si, Ge, Al, Ga, Cr, Mo, W, V, Nb, Ta, Ti, Zr, Hf, La, Ce, Pr, Nd, Pm, Sm, Eu, Gd, Tb, Dy, Ho, Er, Tm, Yb, and Lu, e.g, Fe—Cr, Fe—Si—Al, Fe—Si, Fe—Al, Fe—Co—Si, Fe—Co—Al, Fe—Co—Si—Al, Fe—Co—Ti, Fe(Ni, Co)—Pt, Fe(Ni, Co)—Pd, Fe(Ni, Co)—Rh, Fe(Ni, Co)—Ir, Fe(Ni, Co)—Ru, or Fe—Pt; a half metallic material with a composition expressed by X⁶—Mn—Sb, where X⁶ is at least one element selected from the group consisting of Ni, Cu, and Pt; Fe₃O₄, a material with a composition expressed by (D, G)-J-O₃, a material with a composition expressed by (D, G)-J₂-O_{5+d}, and a half metallic material such as CrO₂, where D is at least one element selected from lanthanide, G is at least one element selected from alkaline-earth elements, J is at least one element selected from transition-metal elements of Groups IVa to VIIa, Group VIII, and Groups Ib to IIIb, and d satisfies 0≦d≦1.5; a magnetic semiconductor with a composition expressed by X⁷—X⁸—X⁹, where X⁷ is at least one element selected from the group consisting of Sc, Y, lanthanide (including La and Ce), Ti, Zr, Hf, Nd, Ta, and Zn, X⁸ is at least one element selected from the group consisting of C, N, O, F, and S, and X⁹ is at least one element selected from the group consisting of V, Cr, Mn, Fe, Co, and Ni; a magnetic semiconductor with a composition expressed by X⁹—X¹⁰—X¹¹, where X⁹ is at least one element selected from the group consisting of V, Cr, Mn, Fe, Co, and Ni, X¹⁰ is at least one element selected from the group consisting of B, Al, Ga, and In, and X¹¹ is at least one element selected from the group consisting of As, C, N, O, P, and S, e.g., Ga—Mn—N, Al—Mn—N, Ga—Al—Mn—N, or Al—B—Mn—N; and a perovskite-type oxide, a spinel-type oxide such as a ferrite, or a garnet-type oxide.

In particular, the magnetic layer 6 that serves as a free layer may use, e.g., the same material as that for the soft magnetic layer.

The thickness of the magnetic layers 6, 7 is not particularly limited and can be set arbitrarily according to the necessary properties for the MR element 9. For example, the-thickness may be in the range of 0.2 nm to 100 nm.

A material for the non-magnetic layer 8 may be either a conductive material or insulating material as long as it has the non-magnetic property. With the conductive material, the magnetoresistive element serves as a so-called GMR element. With the insulating material, the magnetoresistive element serves as a so-called TMR element.

Examples of the non-magnetic conductive material include at least one element selected from the group consisting of Cr, Cu, Ag, Au, Ru, Ir, Re, and Os, and an alloy or oxide of these elements. When the conductive material is used for the non-magnetic layer, the thickness may be, e.g., in the range of 0.2 nm to 1.2 nm.

The non-magnetic insulating material is not particularly limited as long as it is an insulator and/or semiconductor. For example, the non-magnetic insulating material may be a compound of at least one element selected from Groups IIa to VIa such as Mg, Ti, Zr, Hf, V, Nb, Ta, Cr, or lanthanide (including La and Ce) and Groups IIb to IVb such as Zn, B, Al, Ga, or Si, and at least one element selected from the group consisting of F, O, C, N, and B. In particular, at least one compound selected from an Al oxide, Al nitride, and Al oxynitride is preferred in view of the properties or the like of the magnetoresistive element. When the insulating layer is used for the non-magnetic layer, the thickness may be, e.g., in the range of 0.2 nm to 10 nm.

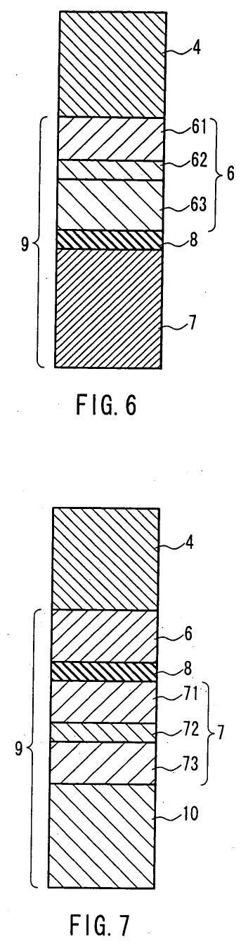

In the reader of the present invention, the MR element 9 may be formed as shown in FIG. 5. The MR element 9 in FIG. 5 further includes an antiferromagnetic layer 10. The antiferromagnetic layer 10 is arranged so that a magnetic layer that is relatively less affected by the magnetic state of a transition material 4 (i.e., a magnetic layer 7 located farther from the transition material 4) is sandwiched between the antiferromagnetic layer 10 and a non-magnetic layer 8. In this MR element, the antiferromagnetic layer 10 and the magnetic layer 7 are coupled magnetically, so that the magnetization direction of the magnetic layer 7 is pinned more stably. Therefore, the MR element can have a larger magnetoresistance effect. FIG. 5 shows the transition material 4 as well as the MR element 9 in order to make the description easy to understand. The same is true for FIGS. 6 and 7.

A material for the antiferromagnetic layer 10 is not particularly limited as long as it has the antiferromagnetic property. Examples of the material include an alloy such as Pt—Mn, Pt—Pd—Mn, Fe—Mn, Ir—Mn or Ni—Mn and a transition-metal oxide with the antiferromagnetic property. The thickness of the antiferromagnetic layer is not particularly limited and may be, e.g., in the range of 0.2 nm to 100 nm.

In the reader of the present invention, at least one of a pair of magnetic layers may include a non-magnetic film and a pair of magnetic films sandwiching the non-magnetic film.

In an MR element 9 of FIG. 6, e.g., a magnetic layer 6 (free layer) includes a non-magnetic film 62 and a pair of magnetic films 61, 63 sandwiching the non-magnetic film 62.

In a multilayer structure that includes a non-magnetic film sandwiched between a pair of magnetic films, the pair of magnetic films can be coupled magnetically by controlling the material and thickness of the non-magnetic film (there are two ways of coupling: laminated ferrimagnetic coupling and magnetostatic coupling). The magnetically effective thickness of the pair of magnetic films in this multilayer structure may be represented substantially by a difference in thickness between the magnetic films rather than the sum of the thicknesses. That is, the magnetic films can have a smaller magnetically effective thickness by controlling such a difference in thickness between the magnetic films. Therefore, when a magnetic layer includes the multilayer structure, the magnetically effective thickness of the magnetic layer further can be reduced. The magnitude of saturation magnetization (the magnitude of demagnetizing field) of the magnetic layer can be reduced by decreasing the magnetically effective thickness of the magnetic layer. This can provide the MR element with higher sensitivity.

In the example of FIG. 6, the magnetization direction of the magnetic layer 6 (free layer) can be changed more easily.

A difference in thickness between the magnetic films 61, 63 is not particularly limited and can be set arbitrarily according to the necessary properties for the magnetic layer. The difference may be, e.g., in the range of 0.2 nm to 2 nm. In this case, the magnetically effective thickness of the magnetic layer including the multilayer structure is 0.2 nm to 2 nm. When the difference is too large, the magnetically effective thickness is not much different from the thickness of a magnetic layer consisting of a single layer, so that the effect is diminished. When the difference is too small, the magnetic layer may not be able to have the necessary properties.

A material for the non-magnetic film 62 is not particularly limited as long as it is a conductive material. For example, at least one element selected from the group consisting of Cr, Cu, Ag, Au, Ru, Ir, Re, and Os may be used. When the thickness of the non-magnetic film 62 is, e.g., in the range of 0.2 nm to 2 nm, though it depends on the material to be used, laminated ferrimagnetic coupling can be established between the magnetic films 61, 63. When the thickness is, e.g., in the range of 2 nm to 100 nm, magnetostatic coupling can be established between the magnetic films 61, 63.

The magnetic layer (free layer) including the multilayer structure can maintain the soft magnetic property without losing magnetization of the free layer even in a fine element.

The laminated ferrimagnetic coupling is particularly effective when the area of a magnetic layer (magnetic film) in the plane direction of the MR element is on the order of submicron or less. The magnetostatic coupling is particularly effective when the area of a magnetic layer (magnetic film) is larger (e.g., on the order of 100 micron or less).

In an MR element 9 of FIG. 7, a magnetic layer 7 (pinned layer) includes a non-magnetic film 72 and a pair of magnetic films 71, 73 sandwiching the non-magnetic film 72. In the MR element 9 of FIG. 7, the magnetic layer 7 (pinned layer) is coupled magnetically with an antiferromagnetic layer 10 and includes the multilayer structure, so that the magnetization direction of the magnetic layer 7 is pinned more stably. When the magnetic films 71, 73 are coupled antiferromagnetically via the non-magnetic film 72 (i.e., the laminated ferrimagnetic coupling), magnetic flux leakage can be suppressed. The magnetic films 71, 73 may be the same as the magnetic films 61, 63, and the non-magnetic film 72 may be the same as the non-magnetic film 62.

The MR element used in the reader of the present invention can include additional layers with desired properties as needed.

The measurement of a magnetoresistance effect by applying a current to the MR element can be performed by a method used for a general MR element. For a TMR element, a current should be applied in the direction perpendicular to the plane direction of the element (via the non-magnetic layer). For a GMR element, a current may be applied either in the direction perpendicular to the plane direction of the element, i.e., CPP (current perpendicular to plane)-GMR or in the direction parallel to the plane direction of the element, i.e., CIP (current in plane) GMR.

To measure the magnetoresistance effect, the detecting portion 3 may include a reference resistance for the MR element 9. In this case, a difference between the resistance and the reference resistance can be read, so that the reader 1 can have more stable properties. As the reference resistance, e.g., a portion of the MR element may be used.

Next, a method for arranging the magnetic displacement portion 2 and the detecting portion 3 will be described.

In the reader of the present invention, the magnetic displacement portion may be either fixed or movable in the direction perpendicular to the surface of the object (the shape of the surface is to be read). In the example of FIG. 1A, the magnetic displacement portion 2 is fixed in the direction perpendicular to the surface of the object 101. In the example of FIG. 2A, the magnetic displacement portion 2 is movable in the direction perpendicular to the surface of the object 101. As described above, the reader of the present invention allows the magnetic displacement portion to be either fixed or movable. The decision on whether the magnetic displacement portion is fixed or movable, or what amount the magnetic displacement portion should be moved can be made arbitrarily according to the necessary properties for the reader or the type of the object. For example, when the shape of the surface of an object is a fingerprint, and the magnetic displacement portion is movable, the amount of moving the magnetic displacement portion in the direction perpendicular to the surface of the object may be, e.g., in the range of about 1 nm to 1000 μm.

In the reader of the present invention, the magnetic displacement portion may be arranged in at least one form selected from a point, a line, and a plane.

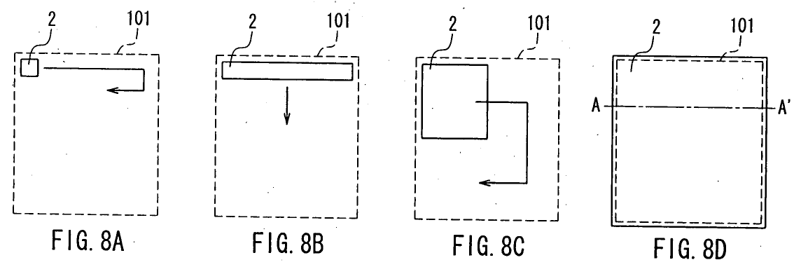

FIGS. 8A to 8D show examples of the arrangement of the magnetic displacement portion of the reader of the present invention. In the example of FIG. 8A, a magnetic displacement portion 2 is arranged in a point form relative to the surface of an object 101 to be read (indicated by a dotted line in FIG. 8A, and the same is true for FIGS. 8B to 8D). In this case, the reader may include a scanning portion for moving the magnetic displacement portion 2, and the scanning portion may move the magnetic displacement portion 2 along the surface of the object 101 to be read (e.g., in the direction parallel to the surface, as indicated by the arrow shown in FIG. 8A), thereby reading the entire surface of the object 101 to be read. In the example of FIG. 8B, a magnetic displacement portion 2 is arranged in a line form relative to the surface of an object 101 to be read. In the example of FIG. 8C, a magnetic displacement portion 2 is arranged in a plane form relative to the surface of an object 101 to be read. In both cases, the magnetic displacement portion 2 can be moved in the same manner as FIG. 8A (e.g., in the directions of the arrows respectively shown in FIGS. 8B and 8C), thereby reading the entire surface of the object 101 to be read. In the example of FIG. 8D, a magnetic displacement portion 2 is arranged in a plane form relative to the surface of an object 101 to be read. The area of the magnetic displacement portion 2 is substantially equal to or larger than the surface of the object 101 to be read. In this case, it is possible to read the entire surface of the object 101 to be read without moving the magnetic displacement portion 2.

Similarly, in the reader of the present invention, the detecting portion may be arranged in at least one form selected from a point, a line, and a plane.

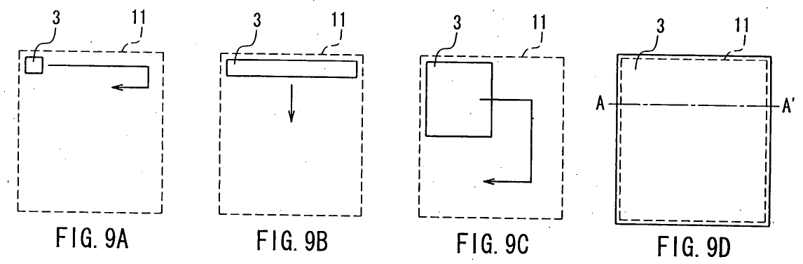

FIGS. 9A to 9D show examples of the arrangement of the detecting portion of the reader of the present invention. The examples of FIGS. 9A to 9D can be considered the same as those of FIGS. 8A to 8D with the magnetic displacement portion 2 replaced by a detecting portion 3 and the surface of the object 101 to be read by a region 11 where the magnetic state of the magnetic displacement portion is to be detected (the region 11 is indicated by a dotted line in FIGS. 9A to 9D). In each of the examples of FIGS. 9A to 9D, the detecting portion 3 can detect the magnetic state of the magnetic displacement portion. When the detecting portion 3 should be scanned as shown in FIGS. 9A to 9C, the reader may include a scanning portion for moving detecting portion 3, and the scanning portion may move the detecting portion 3 along the magnetic displacement portion.

The structure of the scanning portion for moving the magnetic displacement portion 2 and the detecting portion 3 is not particularly limited. For example, a structure/method for moving a head in a printer or scanner or a structure/method for moving a cantilever in a hard disk drive may be applied to the scanning portion. Moreover, a piezoelectric element included, e.g., in an atomic force microscope (AFM) or scanning tunneling microscope (STM) may be used or combined with any of the above structures/methods.

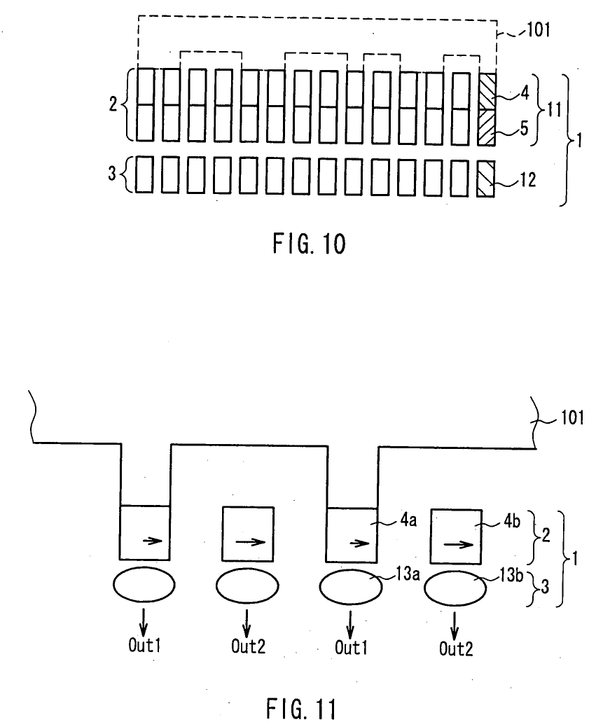

The arrangements of the magnetic displacement portion and the detecting portion can be determined in any configuration. The line-shaped magnetic displacement portion and detecting portion may be formed by assembling point-shaped magnetic displacement portions (magnetic displacement elements) and by assembling point-shaped detecting portions (detecting elements), respectively. Similarly, the plane-shaped magnetic displacement portion and detecting portion may be formed by assembling the magnetic displacement elements and by assembling the detecting elements, respectively. For example, FIG. 10 is a schematic cross-sectional view (taken along the line A-A′ in FIGS. 8D and 9D) showing an example of a reader that includes the magnetic displacement portion 2 in FIG. 8D and the detecting portion 3 in FIG. 9D. In the reader 1 of FIG. 10, the magnetic displacement portion 2 and the detecting portion 3 are formed by assembling magnetic displacement elements 11 and by assembling detecting elements 12, respectively. Each of the magnetic displacement elements 11 includes a point-shaped transition material 4 and a point-shaped soft magnetic layer 5. The individual elements are indicated by the diagonally shaded area in FIG. 10.

The area of the magnetic displacement element in the plane direction (i.e., the direction parallel to the surface of an object) is, e.g., in the range of 100 nm² to 10⁶ μm². The area ranging from 1000 nm² to 10¹⁰ nm² is preferred particularly to read a fingerprint. Although the number of elements required for reading the same region increases as the area becomes smaller, information (e.g., an image that represents the shape of the surface of an object) with higher definition can be read.

Similarly, the area of the detecting element in the plane direction (i.e., the direction parallel to the surface of an object) is, e.g., in the range of 100 nm² to 10⁶ μm². The area ranging from 1000 nm² to 10¹⁰ nm² is preferred particularly to read a fingerprint. Although the number of elements required for detecting the magnetic state of the same region increases as the area becomes smaller, information with higher definition can be read. When the detecting element includes an MR element, and the area of the MR element in the plane direction is, e.g., not more than 1 μm², it is preferable that a free layer of the MR element includes a multilayer structure provided with laminated ferrimagnetic coupling.

The shapes of the magnetic displacement element and the detecting element are not particularly limited, and the shape of the cross section in the plane direction of each element may be, e.g., square, rectangular, circular, elliptical, or polygonal.

FIGS. 11 to 13 show examples of the operation of a reader including a magnetic displacement portion that is formed by assembling magnetic displacement elements and a detecting portion that is formed by assembling detecting elements.

In a reader 1 of FIG. 11, the magnetic state of a transition material 4a in contact with a convex portion of the surface of an object 101 differs from the magnetic state of a transition material 4b not in contact with the convex portion (i.e., facing a concave portion). Such a difference in magnetic state results in a difference in output (Out 1 and Out 2) between coils 13a, 13b of the detecting portion 3, thereby reading the shape of the surface of the object 101.

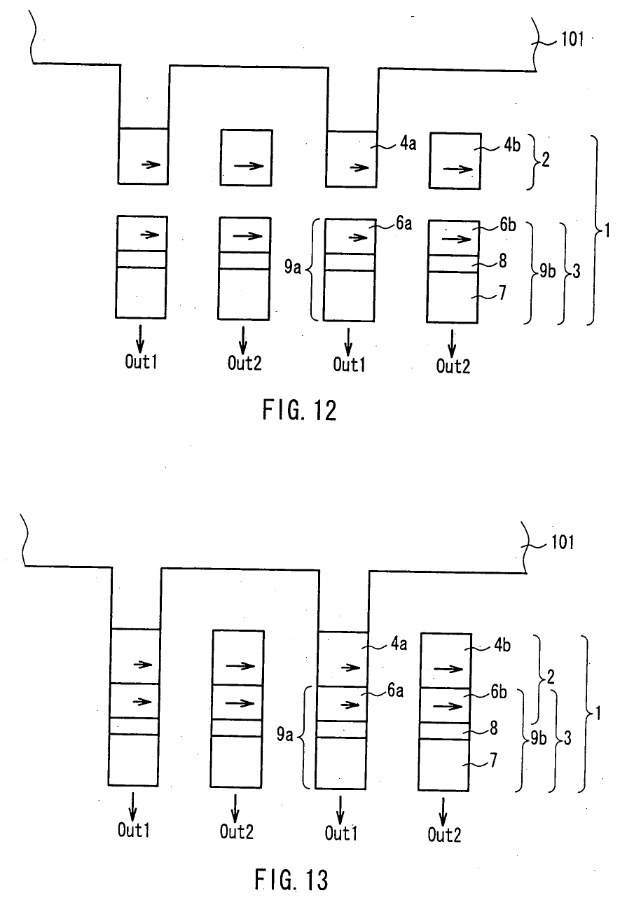

The same is true for the examples of FIGS. 12 and 13. In FIG. 12, a detecting portion 3 includes MR elements. When the magnetic state of a transition material 4a differs from that of a transition material 4b, the magnetization direction of a magnetic layer 6a in an MR element 9a differs from that of a magnetic layer 6b in an MR element 9b. This results in a difference in output between the MR elements 9a, 9b, thereby reading the shape of the surface of an object 101. In FIG. 13, like the example of FIG. 4, a magnetic displacement portion 2 and a detecting portion 3 are formed integrally. In this case, a difference in output between MR elements 9a, 9b also can be used to read the shape of the surface of an object 101.

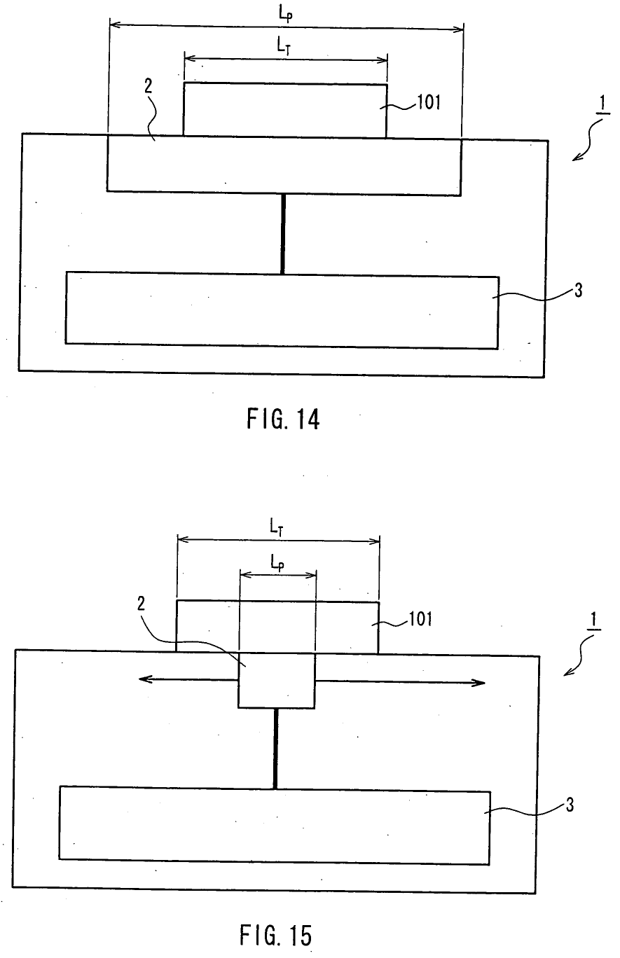

As shown in FIG. 14, when the reader of the present invention reads the shape of the surface of an object 101, the region of a magnetic displacement portion 2 may be larger than the portion of the object 101 to be read (e.g., L_{T}<L_{P} in FIG. 14). In this case, the reader can read the portion of the object 101 to be read by one operation, so that reading can be performed more quickly.

As shown in FIG. 15, when the reader of the present invention reads the shape of the surface of an object 101, the region of a magnetic displacement portion 2 may be smaller than the portion of the object 101 to be read (e.g., L_{T}>L_{P} in FIG. 15). In this case, the reader can read the portion of the object 101 to be read by moving the magnetic displacement portion relative to the object 101 (or by moving the object 101 relative to the magnetic displacement portion 2). To produce an image of the portion of the object 101 to be read, e.g., an image synthesis process is further required. However, it is possible to reduce the size of the reader itself.

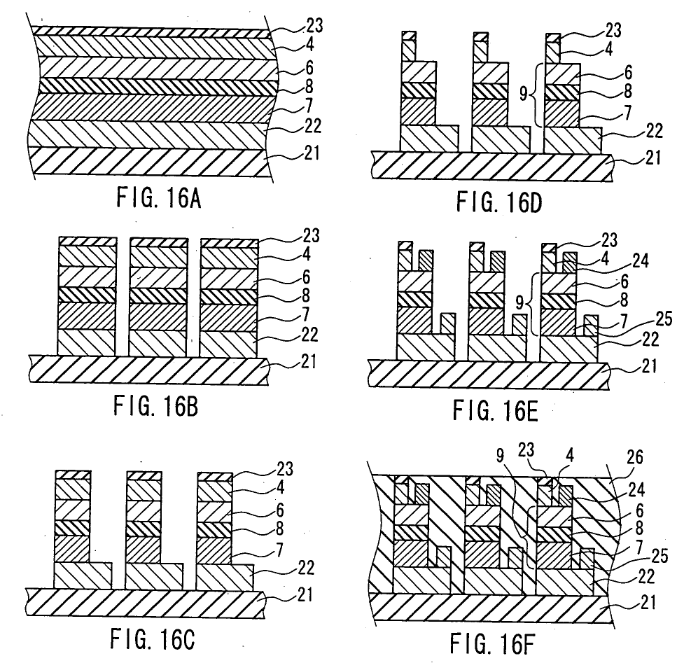

The following is an explanation of a method for manufacturing a reader of the present invention. First, an example of the method for manufacturing a reader of the present invention will be described with reference to FIG. 16.

As shown in FIG. 16A, a laminate is produced by stacking an electrode layer 22, a magnetic layer 7, a non-magnetic layer 8, a magnetic layer 6, a transition material 4, and a protective layer 23 in this order on a Si substrate 21. Then, as shown in FIGS. 16B to 16D, the laminate is microfabricated to form a magnetic displacement portion 2 including the transition material 4 and an MR element 9 serving as a detecting portion. As shown in FIG. 16E, upper and lower electrodes 24, 25 for applying a current to the MR element 9 are formed. Finally, as shown in FIG. 16F, the whole of the laminate is coated with an insulating layer 26, and the surface is polished. Thus, a reader of the present invention can be produced.

A material for the electrode layer 22, the upper electrode 24, and the lower electrode 25 is not particularly limited as long as it is a conductive material. In particular, a material having a linear resistivity of not more than 100 μΩ·cm (e.g., Cu, A, Ag, Au, Pt, or Ti—N) is preferred. A material with an excellent insulating property such as Al₂O₃ or SiO₂ may be used for the insulating layer 26. Any of the above materials may be used for each of the layers.

The individual layers of the laminate and the upper and lower electrodes can be formed by a method that has been used generally to form a semiconductor device, an MR element, or the like. Examples of the method include various types of sputtering such as pulse laser deposition (PLD), ion beam deposition (IBD), cluster ion beam, RF, DC, electron cyclotron resonance (ECR), helicon, inductively coupled plasma (ICP), and facing target sputtering, molecular beam epitaxy (MBE), and ion plating. In addition to these PVD methods, e.g., CVD, plating, or a sol-gel process can be used as well.

The microfabrication also can be performed by a method that has been used generally to form a semiconductor device, an MR element, or the like. For example, physical or chemical etching techniques such as ion milling, reactive ion etching (RIE), and focused ion beam (FIB), a stepper technique for forming fine patterns, and photolithography with an electron beam (EB) method or the like can be used in combination. Moreover, chemical-mechanical polishing (CMP) or cluster ion beam etching may be used to flatten the electrode surface or the like.

The non-magnetic layer made of an insulating material can be formed, e.g., in the following manner. First, a thin film precursor is produced using at least one element selected from Groups IIa to VIa such as Mg, Ti, Zr, Hf, V, Nb, Ta, Cr, or lanthanide (including La and Ce) and Groups IIb to IVb such as Zn, B, Al, Ga or Si. Then, in an atmosphere containing at least one element selected from F, O, C, N, and B as molecules, ions, plasma, or radicals, the thin film precursor is reacted with at least one element selected from F, O, C, N, and B while the temperature and time are controlled. Consequently, the thin film precursor is subjected almost completely to fluoridation, oxidation, carbonization, nitrization, or boration, so that a non-magnetic layer can be produced. A non-stoichiometric compound that includes at least one element selected from F, O, C, N, and B in an amount of not more than the stoichiometric ratio may be used as the thin film precursor.

Specifically, when an Al₂O₃ non-magnetic layer is produced by sputtering, the following processes may be repeated: forming a thin film precursor of Al or AlOx (x≦1.5) in an Ar or Ar+O₂ atmosphere and oxidizing the thin film precursor in the presence of O₂ or O₂+inert gas. A general method such as ECR discharge, glow discharge, RF discharge, helicon, or inductively coupled plasma (ICP) may be used to generate plasma or radicals.

The following is an explanation of an authentication device of the present invention.

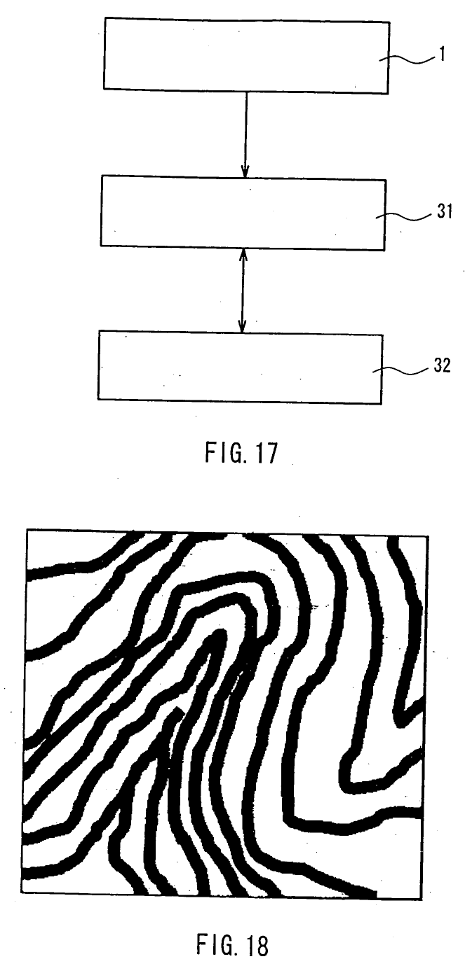

FIG. 17 shows an example of an authentication device of the present invention. The authentication device includes a reader 1, a memory 32, and a matching portion 31. The reader 1 is the same as the reader of the present invention described above. The memory 32 stores the shape of the surface of an object beforehand. The information (e.g., image information) about the shape of the surface of an object is read by the reader 1 and transmitted to the matching portion 31. The matching portion 31 matches the shape transmitted from the reader 1 with the shape stored in the memory 32, and thus the object read by the reader 1 can be verified. A matching method of the matching portion 31 is not particularly limited, and a general matching method may be used.

Unlike a general authentication device including a reader, this authentication device can use a variation in magnetic state (magnetic displacement) as a detection technique. Therefore, the authentication device is less affected by the environment such as static electricity and temperature. This authentication device also can achieve a smaller size and lower power consumption because optical components (e.g., a light source or lens) or other components (e.g., a heater) can be removed. As with the reader of the present invention, the authentication device may have these effects selectively.

The authentication device of the present invention further may include a processing portion (e.g., image processing portion) for processing the information (e.g., image information) of a shape read by the reader 1, and the processing portion may be located between the reader 1 and the matching portion 31. For example, when the reader 1 (e.g., the reader as shown in FIG. 1A) reads the image information about the shape of the surface of an object part by part, the processing portion may synthesize them into image information that represents the shape of the entire surface of the object and transmit this image information to the matching portion 31.

In the authentication device of the present invention, the reader, the memory, and the matching portion do not necessarily need to be physically independent of one another. These names are used merely to identify the functions. The same is true for the processing portion. The authentication device of the present invention can be configured, e.g., by including a computer that contains a memory and a matching portion (and a processing portion, if necessary) other than the reader of the present invention. The authentication device also can be configured, e.g., by forming a semiconductor chip that contains a memory and a matching portion (and a processing portion, if necessary) and the reader of the present invention in a single package.

### EXAMPLES

Hereinafter, the present invention will be described in more detail by way of examples. The present invention is not limited to the following examples.

### Example 1

A laminate having the following film configuration was formed on a Si substrate provided with a thermal oxide film (the thermal oxide film was a SiO₂ film with a thickness of 500 nm) by magnetron sputtering.

Ta(10)/Cu(50)/Ta(5)/Pt—Mn(20)/Co—Fe(4)/Ru(0.9)/Co—Fe(2)/Fe—Pt(2)/Al—O(1)/Fe—Pt(1)/Ni—Fe(2)/Ru(0.7)/Ni—Fe(2)/Fe—Si(2000)/Pt(50)

The figure in parentheses represents the film thickness in nm, and the film thickness is expressed in the same manner in the following. The Al—O layer was produced by depositing Al in a thickness of 1 nm and repeating oxidation of the Al film for one minute in an oxygen containing atmosphere at 26.3 kPa (200 Torr).

Ta(10)/Cu(50)/Ta(5) on the substrate is an electrode layer. Pt—Mn(20) is an antiferromagnetic layer. Co—Fe(4)/Ru(0.9)/Co—Fe(2)/Fe—Pt(2) is a magnetic layer and serves as a pinned layer by being coupled magnetically with Pt—Mn(20). Laminated ferrimagnetic coupling is established between magnetic films of Co—Fe(4) and Co—Fe(2) that sandwich a non-magnetic film of Ru(0.9). Al—O(1.0) is a non-magnetic layer made of an insulating material. Fe—Pt(1)/Ni—Fe(2)/Ru(0.7)/Ni—Fe(2) is a magnetic layer that corresponds to a free layer. Laminated ferrimagnetic coupling is established between Fe—Pt(1)/Ni—Fe(2) and Ni—Fe(2) that sandwich a non-magnetic film of Ru(0.7). As described above, the magnetically effective thickness of the free layer is 1 nm due to the laminated ferrimagnetic coupling. Fe—Si(2000) is a transition material, and Pt(50) is a protective layer. The composition of the Fe—Si layer is Fe_{0.965}Si_{0.035}, expressed by an atomic composition ratio.

This laminate was microfabricated as shown in FIGS. 16B to 16D. After the formation of upper and lower electrodes as shown in FIG. 16E, the laminate was coated with an insulating layer, and the surface was polished, thus producing a reader as shown in FIG. 16F. The microfabrication was performed using ion etching with a resist pattern formed by photolithography. The upper and lower electrodes were made of Cu, and the insulating layer was made of SiO₂. The surface was polished by CMP. As a result of the microfabrication, the reader included 256×256 magnetic displacement elements and detecting elements that were arranged in a plane, and each of the elements was square in shape and had an area of 100 μm² in the plane direction.

A read test of the reader thus produced was conducted by using a fingerprint as the shape of the surface of an object, and an image as shown in FIG. 18 was obtained. When this image information was matched with a fingerprint image that was stored in the memory beforehand, the fingerprint authentication was performed successfully.

The same result also was obtained by changing the thickness of the Al—O non-magnetic layer (0.3 nm to 3 nm) or by using a conductive material of Cu (0.2 nm to 10 nm) for the non-magnetic layer. Moreover, the same result also was obtained by using Dy—Tb—Fe(2000) or Fe—Si having a different composition ratio than that described above as the transition material.

### Example 2

Like Example 1, a laminate having the following film configuration was formed on a Si substrate provided with a thermal oxide film (the thermal oxide film was a SiO₂ film with a thickness of 500 nm) by magnetron sputtering. Al—O (1) was produced in the same manner as Example 1.

Ta(5)/Cu(50)/Ta(5)/Pt—Mn(20)/Co—Fe(4)/Ru(0.9)/Co—Fe(2)/Fe—Pt(2)/Al—O(1)/Fe—Pt(2)/Ni—Fe(6)/Ru(0.9)/Ni—Fe(10)/BiMnO₃(1000)

Ta(5)/Cu(50)/Ta(5) on the substrate is an electrode layer. Pt—Mn(20) is an antiferromagnetic layer. Co—Fe(4)/Ru(0.9)/Co—Fe(2)/Fe—Pt(2) is a magnetic layer and serves as a pinned layer by being coupled magnetically with Pt—Mn(20). Laminated ferrimagnetic coupling is established between magnetic films of Co—Fe(4) and Co—Fe(2) that sandwich a non-magnetic film of Ru(0.9). Al—O(1) is a non-magnetic layer made of an insulating material. Fe—Pt(2)/Ni—Fe(6)/Ru(0.9)/Ni—Fe(10) is a magnetic layer that corresponds to a free layer. Laminated ferrimagnetic coupling is established between Fe—Pt(2)/Ni—Fe(6) and Ni—Fe(10) that sandwich a non-magnetic film of Ru(0.9). BiMnO₃(1000) is a transition material.

This laminate was microfabricated in the same manner as Example 1, and a reader as shown in FIG. 16F was produced. As a result of the microfabrication, the reader included 256×256 magnetic displacement elements and detecting elements that were arranged in a plane, and each of the elements was square in shape and had an area of 100 μm² in the plane direction.

A read test of the reader thus produced was conducted by using a fingerprint as the shape of the surface of an object. Like Example 1, an image as shown in FIG. 18 was obtained. When this image information was matched with a fingerprint image that was stored in the memory beforehand, the fingerprint authentication was performed successfully.

The same result also was obtained by changing the thickness of the Al—O non-magnetic layer (0.3 nm to 3 nm) or by using a conductive material of Cu (0.2 nm to 10 nm) for the non-magnetic layer.

### Example 3

Like Example 1, a laminate having the following film configuration was formed on a Si substrate provided with a thermal oxide film (the thermal oxide film was a SiO₂ film with a thickness of 500 nm) by magnetron sputtering. Al—O (1.0) was produced in the same manner as Example 1.

Ta(10)/Cu(50)/Ta(5)/Pt—Mn(20)/Co—Fe(4)/Ru(0.9)/Co—Fe(4)/Al—O(1.0)/Co—Fe(1)/Ni—Fe(4)/Fe—Al(2000)/Ta(50)

Ta(10)/Cu(50)/Ta(5) on the substrate is an electrode layer. Pt—Mn(20) is an antiferromagnetic layer. Co—Fe(4)/Ru(0.9)/Co—Fe(4) is a magnetic layer and serves as a pinned layer by being coupled magnetically with Pt—Mn(20). Laminated ferrimagnetic coupling is established between magnetic films of Co—Fe(4) and Co—Fe(4) that sandwich a non-magnetic film of Ru(0.9). Al—O(1.0) is a non-magnetic layer made of an insulating material. Co—Fe(1)/Ni—Fe(4) is a magnetic layer that corresponds to a free layer. Fe—Al(2000) is a transition material. The composition of the Fe—Al layer is Fe_{0.9}Al_{0.1}, expressed by a weight ratio. Ta(50) is a protective layer.

This laminate was microfabricated in the same manner as Example 1, and a reader as shown in FIG. 16F was produced. As a result of the microfabrication, the reader included 256×256 magnetic displacement elements and detecting elements that were arranged in a plane, and each of the elements was square in shape and had an area of 100 μm² in the plane direction.

A read test of the reader thus produced was conducted by using a fingerprint as the shape of the surface of an object. Like Example 1, an image as shown in FIG. 18 was obtained. When this image information was matched with a fingerprint image that was stored in the memory beforehand, the fingerprint authentication was performed successfully.

The same result also was obtained by changing the thickness of the Al—O non-magnetic layer (0.3 nm to 3 nm) or by using a conductive material of Cu (0.2 nm to 10 nm) for the non-magnetic layer. Moreover, the same result also was obtained by using Fe—Al—Si including sendust or Tb—Dy—Fe as the transition material.

### Example 4

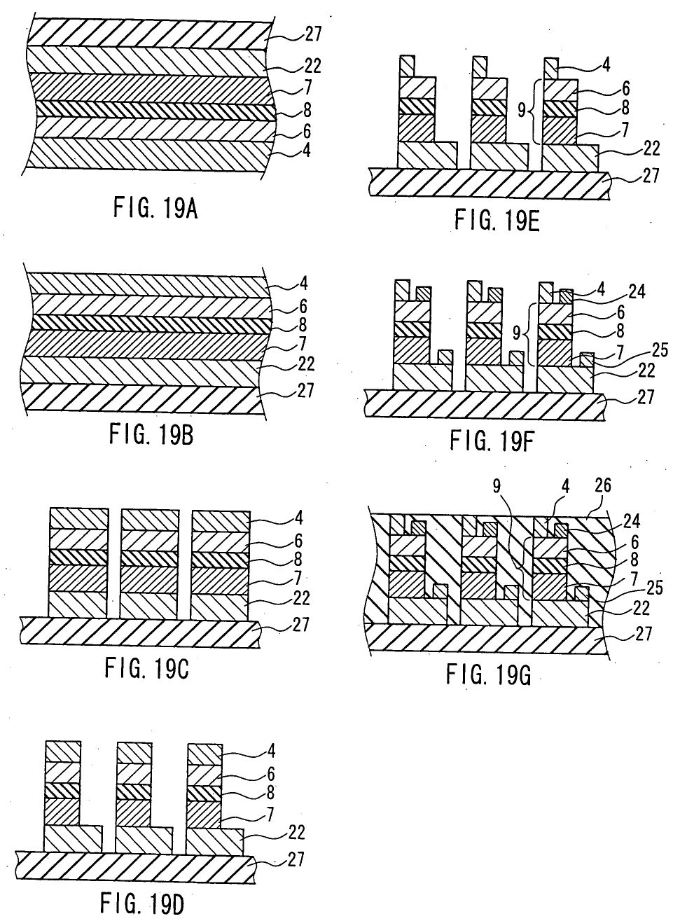

A laminate as shown in FIG. 19A, specifically having the following film configuration, was produced by magnetron sputtering. For easier understanding of the drawing, an antiferromagnetic layer is not shown in FIG. 19A.

TbIG/Ni—Fe(20)/Co—Fe(2)/Al—O(3)/Co—Fe(6)/Ru(0.9)/Co—Fe(6)/Ir—Mn(50)/Ta(10)/Cu(50)/Ta(5)/CAP layer

The Al—O layer was produced by depositing Al in a thickness of 3 nm and repeating oxidation of the Al film for one minute in an oxygen containing atmosphere at 26.3 kPa (200 Torr).

The TbIG (terbium iron garnet) layer was used not only as a transition material 4, but also as a substrate for forming the laminate.

Ni—Fe(20)/Co—Fe(2) on the TbIG layer is a magnetic layer 6 that corresponds to a free layer. Ir—Mn(50) is an antiferromagnetic layer. Co—Fe(6)/Ru(0.9)/Co—Fe(6) is a magnetic layer 7 and serves as a pinned layer by being coupled magnetically with Ir—Mn(50). Al—O(3) is a non-magnetic layer 8 made of an insulating material. Ta(10)/Cu(50)/Ta(5) is an electrode layer 22. A polyimide layer (with a thickness of about 10 μm) formed by spin coating is used as the CAP layer 27.

Next, as shown in FIG. 19B, the CAP layer 27 was used instead of the substrate, and the surface of the TbIG layer (the transition material 4) was polished, thereby processing the TbIG layer to a thickness suitable for the transition material. The TbIG layer was considered to be in a polycrystalline or monocrystalline state. In this example, the TbIG layer was polished until it had a thickness of about several μm.

This laminate was microfabricated as shown in FIGS. 19C to 19E. After the formation of upper and lower electrodes 24, 25 as shown in FIG. 19F, the laminate was coated with an insulating layer 26, and the surface was polished. Thus, a reader was produced as shown in FIG. 19G. The microfabrication was performed in the same manner as Example 1. The upper and lower electrodes were made of Cu, and the insulating layer was made of SiO₂. The surface was polished by CMP. As a result of the microfabrication, the reader included 256×256 magnetic displacement elements and detecting elements that were arranged in a plane, and each of the elements was square in shape and had an area of 100 μm² in the plane direction.

A read test of the reader thus produced was conducted by using a fingerprint as the shape of the surface of an object. Like Example 1, an image as shown in FIG. 18 was obtained. When this image information was matched with a fingerprint image that was stored in the memory beforehand, the fingerprint authentication was performed successfully.

The same result also was obtained by changing the thickness of the Al—O non-magnetic layer (0.3 nm to 3 nm) or by using a conductive material of Cu (0.2 nm to 10 nm) for the non-magnetic layer. Moreover, the same result also was obtained by using rare-earth iron garnet (e.g., Sm or Dy as a rare-earth element) as the transition material.

The processes in FIGS. 19C to 19F may be performed in the same manner as those in FIGS. 16B to 16E. The CAP layer 27 is not particularly limited as long as it can be used instead of the substrate during the processes in FIGS. 19B to 19G. The CAP layer 27 can be made of various materials (e.g., a resin or inorganic substance) other than polyimide. A method for forming the CAP layer 27 is not limited to spin coating, and there is no particular limitation to the method. Similarly, the thickness of the CAP layer 27 also is not particularly limited.

As described above, the present invention can provide a reader that uses the magnetic displacement as a detection technique and an authentication device using the reader.

The reader of the present invention can read, e.g., the shape of the surface of a human body (such as a fingerprint or palm print). Therefore, the reader can be used, e.g., in an authentication device or pointing device. The reader also can be used, e.g., in a surface sensor that can read not only the surface of a human body, but also the surface of various objects.

The authentication device of the present invention can be applied, e.g., to the authentication of computer users or the control of entering/exiting a security area. The authentication device also can be applied, e.g., to various services (including the transmission of information using communication lines such as the Internet) of a financial institution that require the authentication of individuals, such as an automatic teller machine (ATM).

The invention may be embodied in other forms without departing from the spirit or essential characteristics thereof The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A reader for reading a shape of a surface of an object comprising:
a magnetic displacement portion; and
a detecting portion,
wherein when the magnetic displacement portion comes into contact with the surface of the object, a magnetic state of the magnetic displacement portion differs depending on the shape of the surface, and
the detecting portion detects the magnetic state of the magnetic displacement portion.

2. The reader according to claim 1, wherein the shape of the surface includes a convex portion and a concave portion, and
the magnetic state of the magnetic displacement portion differs between a region facing the convex portion and a region facing the concave portion due to a pressure generated by contact of the surface with the magnetic displacement portion.

3. The reader according to claim 2, wherein the magnetic displacement portion comprises a transition material for converting mechanical energy into magnetic energy.

4. The reader according to claim 3, wherein the transition material comprises a magnetostrictive material.

5. The reader according to claim 3, wherein the transition material comprises a material with a composition expressed by Fe—Z, where Z is at least one element selected from the group consisting of Mn, Co, Ni, Cu, Al, Si, Ga, Pd, Pt, Tb, and Dy.

6. The reader according to claim 3, wherein an amount of change in deformation of the transition material is not less than 10⁻³%.

7. The reader according to claim 3, wherein the magnetic displacement portion further comprises a soft magnetic layer,
the soft magnetic layer and the transition material are coupled magnetically, and
a magnetic state of the soft magnetic layer differs depending on a magnetic state of the transition material.

8. The reader according to claim 1, wherein the detecting portion comprises a coil and detects the magnetic state by using the coil.

9. The reader according to claim 1, wherein the detecting portion comprises a magnetoresistive element and detects the magnetic state by using the magnetoresistive element.

10. The reader according to claim 9, wherein the magnetoresistive element comprises a multilayer structure that comprises a non-magnetic layer and a pair of magnetic layers sandwiching the non-magnetic layer,
a resistance value differs depending on a relative angle between magnetization directions of the magnetic layers,
the magnetic displacement portion comprises a transition material for converting mechanical energy into magnetic energy, and
the magnetization direction of one of the magnetic layers differs depending on a magnetic state of the transition material.

11. The reader according to claim 10, wherein one of the magnetic layers and the transition material are coupled magnetically.

12. The reader according to claim 10, wherein the magnetoresistive element further comprises an antiferromagnetic layer, and
the antiferromagnetic layer is arranged so that the other magnetic layer is sandwiched between the antiferromagnetic layer and the non-magnetic layer.

13. The reader according to claim 10, wherein at least one magnetic layer selected from the pair of magnetic layers comprises a non-magnetic film and a pair of magnetic films sandwiching the non-magnetic film.

14. The reader according to claim 13, wherein magnetic coupling selected from laminated ferrimagnetic coupling and magnetostatic coupling is established between the pair of magnetic films.

15. The reader according to claim 1, wherein the magnetic displacement portion is fixed in a direction perpendicular to the surface of the object.

16. The reader according to claim 1, wherein the magnetic displacement portion is movable in a direction perpendicular to the surface of the object.

17. The reader according to claim 1, wherein the magnetic displacement portion is arranged in at least one form selected from a point, a line, and a plane.

18. The reader according to claim 1, wherein the detecting portion is arranged in at least one form selected from a point, a line, and a plane.

19. The reader according to claim 1, further comprising a first scanning portion for moving the magnetic displacement portion,
wherein the first scanning portion moves the magnetic displacement portion along the surface of the object so that the shape of the surface is read.

20. The reader according to claim 1, further comprising a second scanning portion for moving the detecting portion,
wherein the second scanning portion moves the detecting portion along the magnetic displacement portion so that the magnetic state of the magnetic displacement portion is detected.

21. The reader according to claim 1, wherein the object is a human body.

22. The reader according to claim 21, wherein the shape of the surface is a fingerprint.

23. An authentication device comprising:
a reader;
a memory; and
a matching portion,
wherein the reader reads a shape of a surface of an object and comprises a magnetic displacement portion and a detecting portion, wherein when the magnetic displacement portion comes into contact with the surface of the object, a magnetic state of the magnetic displacement portion differs depending on the shape of the surface, and the detecting portion detects the magnetic state of the magnetic displacement portion,
the memory stores a shape of a surface of an object beforehand, and
the matching portion matches the shape read by the magnetic displacement portion with the shape stored in the memory.
